(19) United States
(12) Patent Application Publication
(10) Pub. No.: US 2012/0217062 A1
(43) Pub. Date: Aug. 30, 2012

(54) Automatic Splice with Integral Center Stop

(75) Inventors: Matthew D. Cawood, De Leon Springs, FL (US); Edward Hielscher, Ormond Beach, FL (US)

(73) Assignee: THOMAS & BETTS INTERNATIONAL, INC., Wilmington, DE (US)

(21) Appl. No.: 13/033,802

(22) Filed: Feb. 24, 2011

(51) Int. Cl. H02G 15/08; H01R 43/20

(52) U.S. Cl. 174/84 R; 29/876

(57) ABSTRACT

An automatic splice connector has an outer casing formed from a solid piece of conductive alloy. Thus, the automatic splice connector of the present invention generally includes a unitary casing having a longitudinal axis along which first and second ends of the casing taper conically toward the axis. The first end of the casing terminates at a first aperture and the second end of the casing terminates at a second aperture. The casing has an internal integral wall formed perpendicular to the longitudinal axis midway along the axial length of the casing, wherein the wall and the casing are contiguously formed as one piece.

### BACKGROUND OF THE INVENTION

The present invention relates generally to cable splice devices for longitudinally connecting two ends of a cable. More particularly, the present invention relates to an automatic splice connector having low overall manufacturing cost in terms of reduced raw material, components and assembly steps.

Connectors for longitudinally splicing two lengths of cable or other electrical connectors together, commonly referred to as “automatic splices,” have long been known. Such devices are typically used by power utility linemen to quickly splice lengths of overhead or otherwise suspended high voltage cable together and have become a mainstay in the electrical utility industry. Originally developed for emergency restoration, the automatic splice has evolved into a nominal construction component for overhead power lines, and has been extensively used in the industry for over seventy years.

An early version of the automatic splice is disclosed in U.S. Pat. No. 3,205,300 to Becker. The opposed ends of Becker's device each contain a set of tapered jaws. The lineman inserts the cable ends through apertures provided in each of the opposed ends of the device. After inserting suitable lengths of each cable into the device, the lineman draws the cables longitudinally away from the device. This action pulls the jaws into the tapered ends of the device's casing, thereby securely clamping the jaws on to the cable.

However, even modern automatic splice connectors still have numerous components, which require careful assembly and installation. Additionally, the cost of the raw materials of these automatic splice connectors remains high.

Accordingly, it would be desirable to provide a low cost automatic splice made with less raw material, fewer components and reduced assembly steps.

### SUMMARY OF THE INVENTION

The present invention provides an automatic splice connector with an outer casing formed from a solid piece of conductive alloy. Thus, the automatic splice connector of the present invention generally includes a unitary casing having a longitudinal axis along which first and second ends of the casing taper conically toward the axis. The first end of the casing terminates at a first aperture and the second end of the casing terminates at a second aperture. The casing has an internal integral wall formed perpendicular to the longitudinal axis midway along the axial length of the casing, wherein the wall and the casing are contiguously formed as one piece.

The connector further includes a first cable gripping device disposed within the first end of the casing, a second cable gripping device disposed within the second end of the casing, a first biasing element disposed in the casing between the casing integral wall and an inner end of the first cable gripping device for urging the first cable gripping device along the axis towards the first aperture and a second biasing element disposed in the casing between the casing integral wall and an inner end of the second cable gripping device for urging the second cable gripping device along the axis towards the second aperture. A first plug is preferably secured in the first aperture and a second plug is preferably secured in the second aperture.

In a preferred embodiment, the casing is made of aluminum and the integral wall is formed with an axial through-hole to permit water flow between the first and second ends of the casing. Also, each of the first and second plugs preferably includes a tapered funnel guide fitted within a respective aperture and a pilot cup disposed within the funnel guide for receiving an end of a cable. The first and second plugs respectively temporarily prevent the first and second springs from advancing the first and second set of jaws towards the first and second apertures.

In addition, each of the first and second cable gripping devices are preferably in the form of a cooperating set of cable gripping jaws having a conically tapered outer surface conforming to the conically shaped first and second ends of the casing. Each of the first and second set of cable gripping jaws further preferably defines a semi-cylindrical inner surface bearing serrated teeth for gripping a cable.

The present invention further involves a method for manufacturing an automatic splice, which utilizes cold forming, or other similar process, to eliminate the need for seamless tube and improve manufacturability. Thus, the method according to the present invention generally includes the step of forming a unitary casing from a solid slug of metallic material, wherein the casing has a longitudinal axis, a first end terminating at a first aperture, a second end terminating at a second aperture longitudinally opposite the first aperture and an internal integral wall formed perpendicular to the longitudinal axis midway along the axial length of the casing, and wherein the wall and the casing are contiguously formed as one piece.

The method according to the present invention further includes the step of inserting a first biasing element within the first end of the casing, inserting a first cable gripping device within the first end of the casing such that the first biasing element is disposed between the casing integral wall and an inner end of the first cable gripping device for urging the first cable gripping device along the axis towards the first aperture. A second biasing element is then inserted within the second end of the casing and a second cable gripping device is inserted within the second end of the casing such that the second biasing element is disposed between the casing integral wall and an inner end of the second cable gripping device for urging the second cable gripping device along the axis towards the second aperture. The first and second ends of the casing are then mechanically deformed to form first and second ends that taper conically toward the longitudinal axis. The assembly is complete by securing first and second plugs in the respective first and second apertures.

The casing is preferably formed from a solid slug of aluminum, or other electrically conducting material, using a cold-forming process. The method for forming the casing further preferably includes the step of forming an axial through-hole in the integral wall to permit water flow between the first and second ends of the casing.

In a preferred embodiment, the unitary casing is formed by providing an elongate solid slug of metallic material, inserting a tool along the longitudinal axis in opposite axial ends of the slug to form the casing having respective axial bores formed in opposite ends thereof and stopping the tool short of forming a continuous axial bore in the casing, thereby leaving the internal integral wall in the casing.

A preferred form of the automatic splice, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is a cross-sectional view of an automatic splice connector of the prior art.

FIG. 2 is a cross-sectional view of an automatic splice connector formed in accordance with the present invention.

FIG. 3 is a cross-sectional view of the casing for the automatic splice connector shown in FIG. 2.

FIG. 3a is an enlarged cross-sectional view of the center section of the casing shown in FIG. 3.

### DETAILED DESCRIPTION OF THE PREFERRED EMBODIMENTS

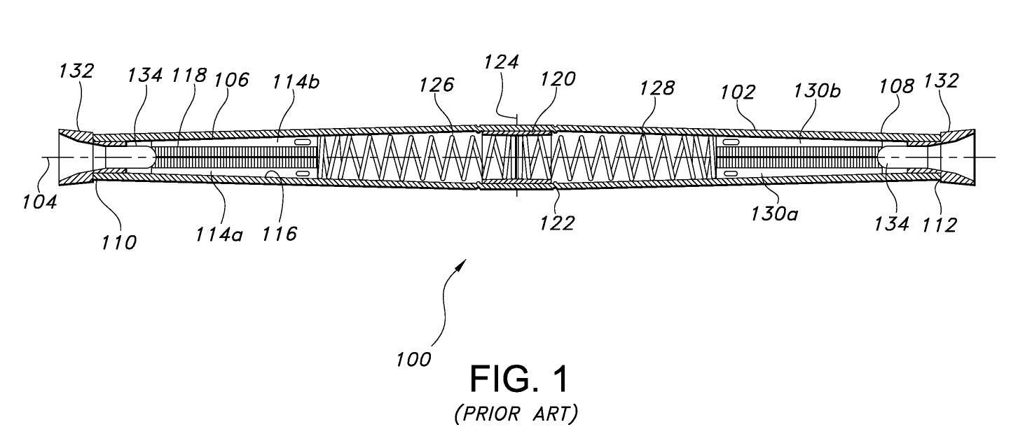

FIG. 1 shows a conventional automatic splice connector 100 of the prior art. The splice connector 100 generally includes an outer metallic casing 102 which is symmetrical about its longitudinal axis 104. The casing 102 is typically made of seamless aluminum tubing and has first and second ends 106, 108, which respectively taper conically toward the longitudinal axis 104. The casing 102 is a tubular body with the first end 106 disposed opposite the second end 108. Both ends are conical and taper away from the center 124 of the splice 100. First and second cable-receiving apertures 110, 112 are provided in casing ends 106, 108 respectively.

A first set of mating, cable-gripping jaws 114a, 114b is disposed within casing first end 106. The jaws 114a, 114b together form a cable enclosure having a conically tapered outer surface which conforms to the shape of the conically tapered inner surface 116 of the casing 102. The jaws 114a, 114b each have semi-cylindrical inner surfaces bearing serrated teeth 118 for gripping a cable, which will be described in further detail below.

A divider plate 120 is fixed in the center of the casing 102, perpendicular to axis 104. Such divider plate 120 is generally made from a plastic material and is typically fixed in place by a staking process, wherein the casing 102 is subsequently mechanically deformed after the divider is positioned. The mechanical deformation of the casing may take the form of protrusions 122 formed on the inner surface 116 of the casing as a result of indenting the casing from the outside. These protrusions 122 fix the divider plate 120 in place at the center 124 of the casing. The casing 102 is then further mechanically deformed to produce the conically tapered ends.

A first spring 126 is compressed between one side of the divider plate 120 and the inner ends of the jaws 114a, 114b. The device 100 is symmetrical about the divider plate 120 and, therefore, the casing's second end 108 contains a second spring 128, which is compressed between the opposite side of the divider plate 120 and the inner ends of a second set of mating, cable-gripping jaws 130a, 130b.

A tapered funnel guide 132 is provided at each end 106, 108 of the interior of the casing 102 to receive a cable. The funnel guide 132 is a device for initially receiving an end of the cable to prevent the cable strands from splaying outwardly in the direction with which the cable strands naturally tend to expand. The funnel guide 132 is open-ended and oriented such that the narrowest region of the funnel is exposed to the interior cavity of the casing 102.

Once the cable penetrates the funnel guide 132, the cable is received within a pilot cup 134 and retracts towards the center section 124 of the splice 100. The pilot cup 134 is a substantially hemispherically shaped or nosed cylinder made out of stainless steel, or other material, and having an open end and a closed end. In its initial position before receiving the cable, the pilot cup 134 rests against the funnel guide 132 such that the open end is adjacent the narrowest region of the funnel guide.

Once the cable and the pilot cup 134 are engaged, the pilot cup nests against the end of the cable such that the open end surrounds the cable and keeps the individual strands of the cable from separating. During further insertion, the end of the cable, covered by the pilot cup 134, enters the interior of the jaws 114a, 114b. As mentioned above, the jaws have a frustoconical shape to approximate the conical section of the casing 102 such that when urged toward the outer tapered ends 106, 108 by the springs 126, 128, the jaws move toward one another and increase the force applied on the cable, thus increasing clamping forces on the cable. As a result, the cable is prevented from being withdrawn once it has been fully inserted into the jaws.

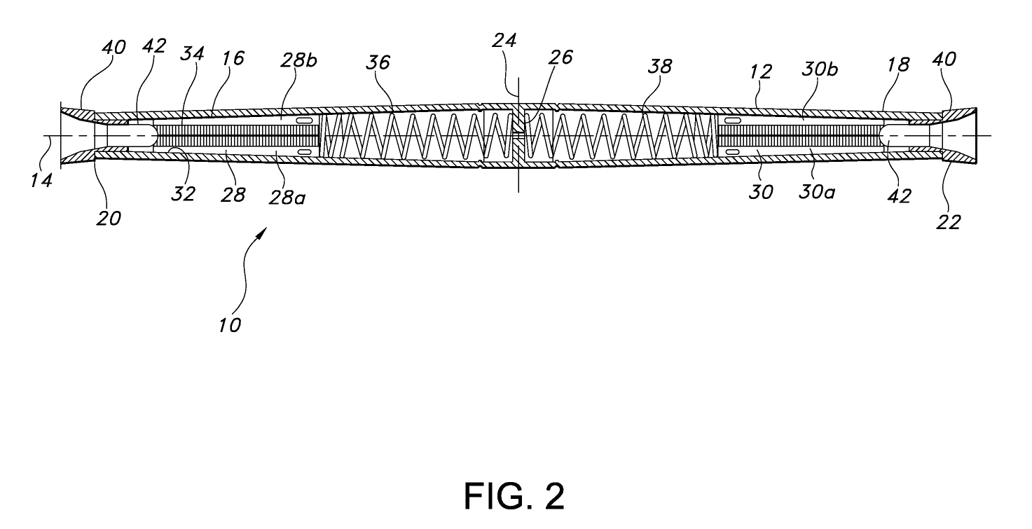

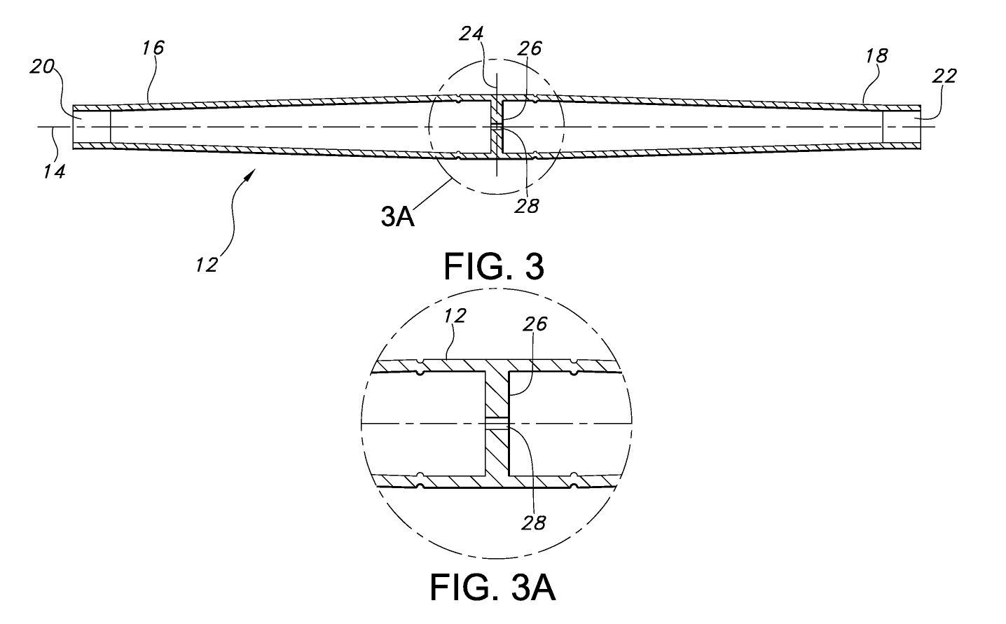

Turning now to FIGS. 2 and 3, the automatic splice connector 10 in accordance with the present invention is shown. The splice connector 10 of the present invention also generally includes an outer metallic casing 12, which is symmetrical about its longitudinal axis 14. Like the casing 102 described above with respect to the prior art, the casing 12 of the present invention has first and second ends 16, 18, which respectively taper conically toward the longitudinal axis 14. The first end 16 is disposed opposite the second end 18 and both ends are conical and taper inward in a direction away from the center 24 of the splice 100. First and second cable-receiving apertures 20, 22 are provided in casing ends 16, 18 respectively.

However, unlike the casing 102 described above with respect to the prior art, the casing 12 of the present invention includes a center stop 26 that is formed integral with the casing body, as shown in further detail in FIG. 3a. In other words, the casing 12 and the center stop 26 are formed as one piece, wherein the center stop is a contiguous extension from the inner surface of the casing 12.

The casing 12 with the integral center stop 26 is preferably formed by cold forming an elongate solid slug of aluminum under pressure to form a seamless tube. In this case, the tooling used to form the tube stops short of forming a continuous bore through the tube. As a result, a center stop 26 is formed, which is an integral or unitary part of the casing 12. Any conventional cold-forming process can be used to form the casing 12, so long as the casing 12 and the integral center stop are formed as one contiguous solid piece.

As shown in FIG. 3, the center stop 26 of the present invention further preferably includes a through-hole 28 extending in the direction of the center axis 14 to permit water to flow from one end of the connector to the other. The through-hole may be formed during the same cold-forming process used to form the center stop 26, or it can be formed by a subsequent process, such as drilling.

Returning to FIG. 2, the remaining components of the splice 10 of the present invention are generally the same as described above with respect to the prior art. Specifically, two cable gripping devices 28, 30 are disposed within respective ends of the casing. In the preferred embodiment, the cable gripping devices are in the form of cooperating sets of mating, cable-gripping jaws 28a, 28b, 30a, 30b. However, it is conceivable that other cable gripping devices, such as collets, can be utilized. The jaws 28a, 28b, 30a, 30b together again form a cable enclosure having a conically tapered outer surface which conforms to the shape of the conically tapered inner surface 32 of the casing 12 and the jaws 28a, 28b, 30a, 30b each have semi-cylindrical inner surfaces bearing serrated teeth 34 for gripping a cable.

Also, biasing elements 36, 38 are provided between the integral center stop 26 and the inner ends of the jaws 28a, 28b, 30a, 30b to urge the jaws against the inner surface 32 of the casing 12, thereby biasing the jaws into a closed cable gripping position. In the preferred embodiment, the biasing elements 36, 36 are springs, but other biasing elements, such as elastomeric materials, rubber or resilient foams, can also be utilized.

Plugs in the form of tapered funnel guides 40 and pilot cups 42, as described above, are provided at opposite ends of the casing 12 for receiving and guiding the cable into the jaws in a manner as described above. In particular, once the end of the cable and the pilot cup 42 are engaged, further insertion of the cable drives the cable into the cable gripping jaws 28a, 28b, 30a, 30b against the bias of the springs 36, 38, which urge the jaws to move toward one another and increase the force applied on the cable. As a result, the cable is prevented from being withdrawn once it has been fully inserted into the jaws.

As a result of the present invention, an automatic splice connector is provided with significantly reduced cost. Specifically, cold forming the outer aluminum body 12 will significantly reduce cost and lead time by: 1) reducing raw material cost; 2) eliminating the additional separate center stop component; and 3) eliminating the staking operation used to contain the center stop. The new process of cold forming of the aluminum body 12 will have a significant impact on overall manufacturing cost by reducing raw material costs and eliminating operations and components.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. An automatic cable splice connector comprising:
a unitary casing having a longitudinal axis along which first and second ends of said casing taper conically toward said axis, said first end of said casing terminating at a first aperture and said second end of said casing terminating at a second aperture and said casing having an internal integral wall formed perpendicular to said longitudinal axis midway along the axial length of said casing, said wall and said casing being contiguously formed as one piece;
a first cable gripping device disposed within said first end of said casing, said first cable gripping device having an inner end and an outer end;
a second cable gripping device disposed within said second end of said casing, said second cable gripping device having an inner end and an outer end;
a first biasing element disposed in said casing between said casing integral wall and said inner end of said first cable gripping device for urging said first cable gripping device along said axis towards said first aperture; and
a second biasing element disposed in said casing between said casing integral wall and said inner end of said second cable gripping device for urging said second cable gripping device along said axis towards said second aperture.

2. An automatic cable splice as defined in claim 1, wherein said casing integral wall is formed with an axial through-hole to permit water flow between said first and second ends of said casing.

3. An automatic cable splice as defined in claim 1, further comprising a first plug secured in said first aperture and a second plug secured in said second aperture, wherein each of said first and second plugs comprises:
a tapered funnel guide fitted within said respective aperture; and
a pilot cup disposed within said funnel guide for receiving an end of a cable.

4. An automatic cable splice as defined in claim 3, wherein said first and second plugs respectively temporarily prevent said first and second biasing elements from advancing said first and second cable gripping devices towards said first and second apertures.

5. An automatic cable splice as defined in claim 1, wherein said casing is made of aluminum.

6. An automatic cable splice as defined in claim 1, wherein each of said first and second cable gripping devices comprises a cooperating set of cable gripping jaws having a conically tapered outer surface conforming to said conically shaped first and second ends of said casing.

7. An automatic cable splice as defined in claim 6, wherein each of said first and second set of cable gripping jaws defines a semi-cylindrical inner surface bearing serrated teeth for gripping a cable.

8. An automatic cable splice as defined in claim 1, wherein said first and second biasing elements are springs.

9. A method for manufacturing an automatic cable splice connector comprising the steps of:
forming a unitary casing from a solid slug of metallic material, said casing having a longitudinal axis, a first end terminating at a first aperture, a second end terminating at a second aperture longitudinally opposite said first aperture and an internal integral wall formed perpendicular to said longitudinal axis midway along the axial length of said casing, said wall and said casing being contiguously formed as one piece;
inserting a first biasing element within said first end of said casing;
inserting a first cable gripping device within said first end of said casing such that said first biasing element is disposed between said casing integral wall and an inner end of said first cable gripping device for urging said first cable gripping device along said axis towards said first aperture;
inserting a second biasing element within said second end of said casing;
inserting a second cable gripping device within said second end of said casing such that said second biasing element is disposed between said casing integral wall and an inner end of said second cable gripping device for urging said second cable gripping device along said axis towards said second aperture; and
deforming said first and second ends of said casing to form first and second ends that taper conically toward said longitudinal axis.

10. A method for manufacturing an automatic cable splice connector as defined in claim 9, wherein said unitary casing is formed using a cold-forming process.

11. A method for manufacturing an automatic cable splice connector as defined in claim 9, further comprising the step of forming an axial through-hole in said integral wall to permit water flow between said first and second ends of said casing.

12. A method for manufacturing an automatic cable splice connector as defined in claim 9, wherein said casing is formed from a solid slug of aluminum.

13. A method for manufacturing an automatic cable splice connector as defined in claim 9, wherein said step of forming said unitary casing comprises the steps of:
providing an elongate solid slug of metallic material;
inserting a tool along said longitudinal axis in opposite axial ends of said slug to form said casing having respective axial bores formed in opposite ends thereof; and
stopping said tool short of forming a continuous axial bore in said casing, thereby leaving said internal integral wall in said casing.

14. A method for manufacturing an automatic cable splice connector as defined in claim 9, further comprising the steps of:
securing a first plug in said first aperture: and securing a second plug in said second aperture.

15. A method for manufacturing an automatic cable splice connector as defined in claim 9, wherein each of said first and second cable gripping devices comprises a cooperating set of cable gripping jaws having a conically tapered outer surface conforming to said conically shaped first and second ends of said casing.

16. A method for manufacturing an automatic cable splice connector as defined in claim 9, wherein said first and second biasing elements are springs.

17. A method for forming a unitary casing of an automatic splice connector comprising the steps of:
providing an elongate solid slug of metallic material;
inserting a tool along a longitudinal axis in opposite axial ends of said slug to form a casing having respective axial bores formed in opposite ends thereof; and
stopping said tool short of forming a continuous axial bore in said casing, thereby leaving an internal integral wall formed perpendicular to said longitudinal axis midway along the axial length of said slug, said wall and said casing being continuously formed as one piece.

18. A method for forming a unitary casing as defined in claim 17, wherein said unitary casing is formed using a cold-forming process.

19. A method for forming a unitary casing as defined in claim 17, further comprising the step of forming an axial through-hole in said integral wall to permit water flow between said first and second ends of said casing.

20. A method for forming a unitary casing as defined in claim 17, wherein said casing is formed from a solid slug of aluminum.
